(19) United States
(12) Patent Application Publication
(10) Pub. No.: US 2007/0209213 A1
(43) Pub. Date: Sep. 13, 2007

(54) Convertible Kitchen Shears

(75) Inventor: Rama Chorpash, New York, NY (US)

Correspondence Address: SELDON & SCILLIERI, 10940 WILSHIRE BLVD., 18TH FLOOR, LOS ANGELES, CA, 90024-3952, US

(73) Assignee: CULINHOME, INC., Los Angeles, CA (US)

(21) Appl. No.: 11/682,045

(22) Filed: Mar. 5, 2007

Related U.S. Application Data
(60) Provisional application No. 60/781,272, filed on Mar. 9, 2006.

(51) Int. Cl. B26B 13/00

(52) U.S. Cl. 30/231; 30/254

(57) ABSTRACT

A pair of kitchen shears comprises a pair of blade members having respective handle portions at their proximal end regions and respective cutting edges at their distal end regions, and a coupling mechanism for coupling the blade members for pivoting movement with respect to each other about a pivot axis generally perpendicular to the blade members so that the cutting edges can be pivoted towards and away from each other about said axis. The coupling mechanism is manually operable to selectively decouple the blade members from each other. At least one of the blade members has a knife edge along its distal end region so it can function as a paring knife when separated from the other blade member.

### FIELD OF THE INVENTION

This invention relates to kitchen cutlery.

### BACKGROUND OF THE INVENTION

There is a demand for kitchen cutlery that can be utilized for multiple types of cutting. In addition to the cost-effectiveness of a multi-purpose implement, multi-purpose cutlery reduces the number of implements that need to be stored and the amount of space needed for storage of same, while increasing the efficiency and convenience of meal preparation.

### SUMMARY OF THE INVENTION

The invention herein is directed to kitchen shears for cutting meat, vegetables, herbs and the like which provides a paring knife for slicing and dicing those and other food items. Shears of this type are sometimes referred to as poultry shears or fish shears; regardless of the name employed, they are used for cutting food items and the invention herein is independent of the particular type of food to be cut.

The shears herein comprises a pair of blade members having respective handle portions at their proximal end regions and respective cutting edges at their distal end regions, and a coupling mechanism for coupling the blade members for pivoting movement with respect to each other about a pivot axis generally perpendicular to the blade members so that the cutting edges can be pivoted towards and away from each other about said axis. The coupling mechanism is manually operable to selectively decouple the blade members from each other. At least one of the blade members has a knife edge along its distal end region so it can function as a paring knife when separated from the other blade member.

These and other details will become apparent from the following description of the preferred embodiment of the invention, of which the Drawing forms a part.

### DESCRIPTION OF THE DRAWING

In the drawing,

FIG. 1 is a front elevation view of kitchen shears constructed in accordance with the invention;

FIG. 2 is a rear elevation view of kitchen shears of FIG. 1;

FIG. 3 is a front elevation view of the disassembled blade members forming the shears of FIG. 1;

FIG. 4 is a front elevation view of the shears of FIG. 1, with the blade members positioned for disassembly;

FIG. 5 is a schematic illustration of the shears of FIG. 1 being held in its open-blade position;

FIG. 6 is a schematic illustration of the shears of FIG. 1 being held in its blade-closed;

FIG. 7 is a front elevation view of the shears of FIG. 1 in its locked-blade position;

FIG. 8 is a magnified detail of the locking mechanism of the shears of FIG. 1;

FIG. 9 is a right side elevation view of the top handle member shown in FIG. 1; and

FIG. 10 is a top plan view of the blade member 22 shown in FIG. 1.

### DETAILED DESCRIPTION OF THE PREFERRED EMBODIMENT

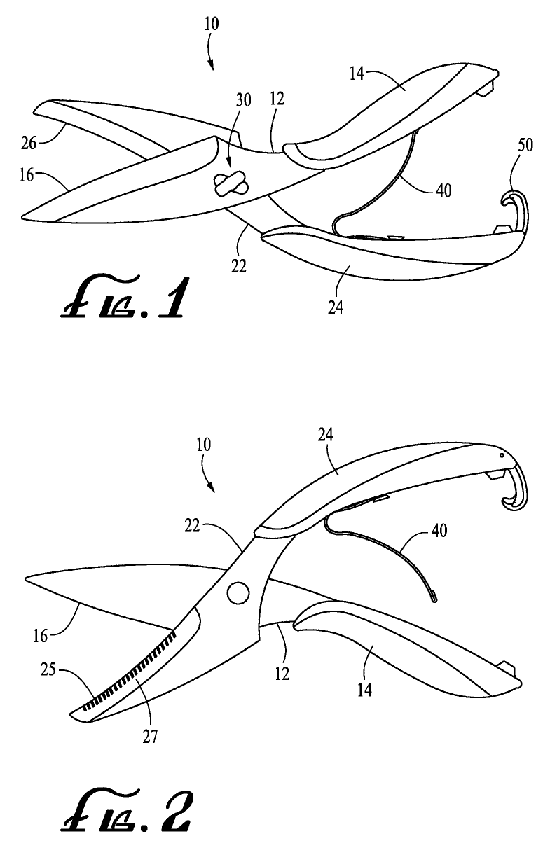

Referring initially to FIG. 1 (a front elevation view of kitchen shears constructed in accordance with the invention), and to FIG. 2 (a rear elevation view thereof), kitchen shears 10 comprise a pair of blade members 12, 22 having respective handle portions 14, 24 at their proximal end regions and respective cutting edges 16, 26 at their distal end regions. The blade member 22 has serrations 27 on its outer surface adjacent the cutting edge 26 for resisting the slippage of food from between the two cutting edges arising from the shearing force of the blades.

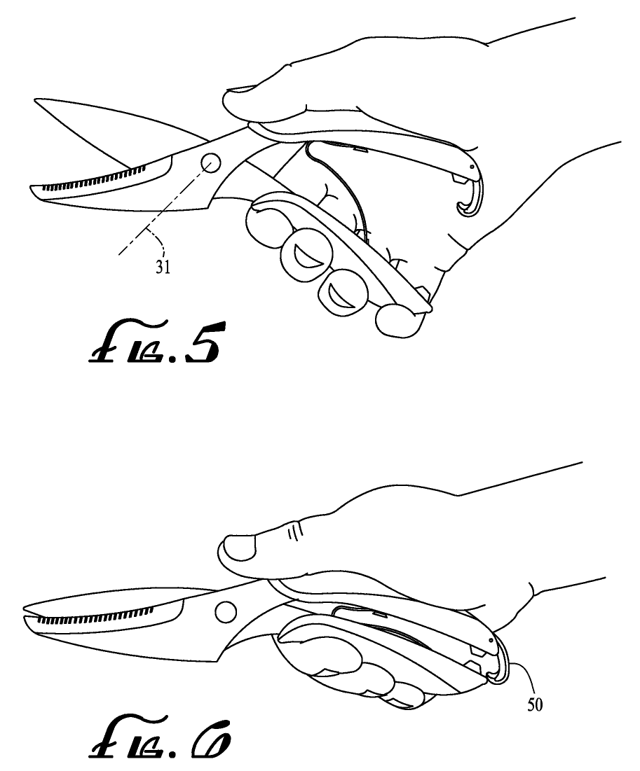

A coupling mechanism 30 is provided for coupling the blade members 12, 22 for pivoting movement with respect to each other about a pivot axis generally perpendicular to the plane of the blade members so that the cutting edges can be pivoted towards and away from each other about said axis 31 as illustrated in FIGS. 5 and 6.

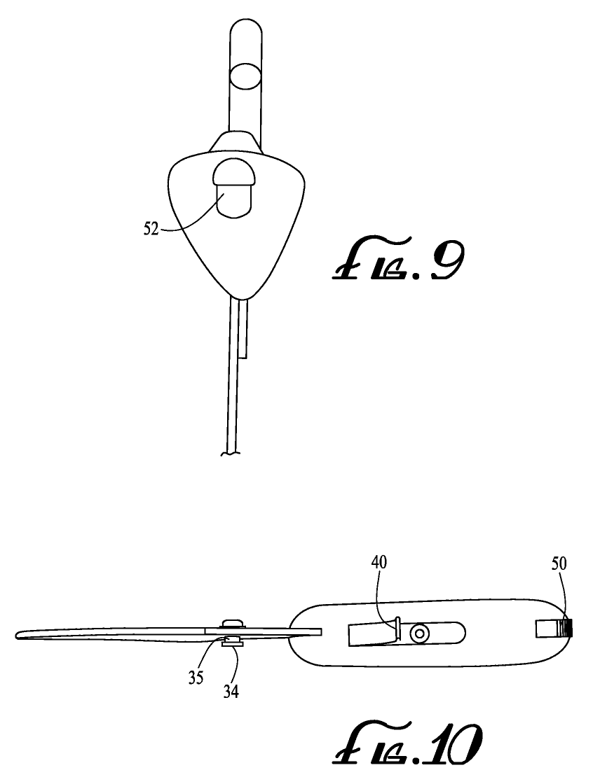

As best shown in FIGS. 1 and 6-8, a hook-shaped locking device 50 is mounted on the end of handle portion 24 for pivoting movement about an axis perpendicular to the plane of the drawing. As shown in FIGS. 8 and 9, the locking device pivots into a recess 52 formed in the end of handle portion 14 to secure the shears in a closed-blade position for safe storage and handling. Numerous other types of locking mechanisms are known in the art and are within the scope of the invention, which is not dependant on the particular type of locking mechanism or even the presence of such a mechanism.

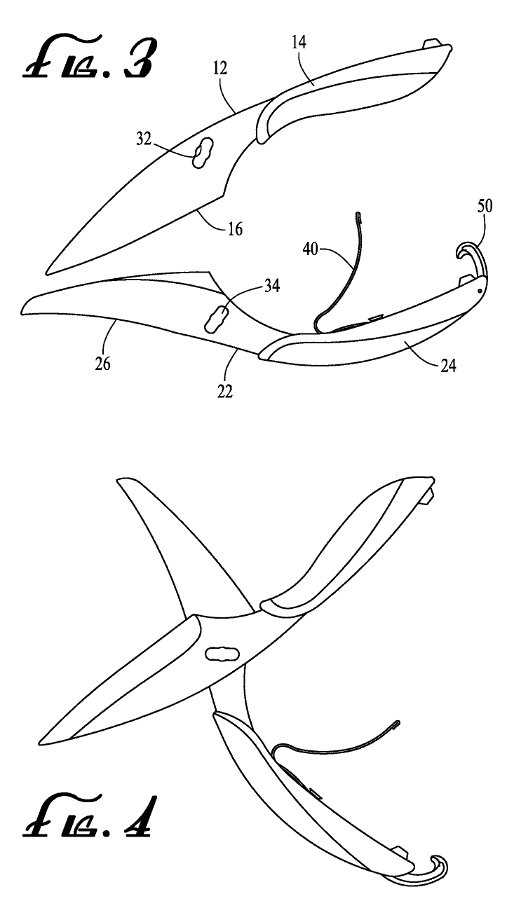

The coupling mechanism 30 is manually operable to selectively decouple the blade members from each other, as illustrated in FIG. 3. More specifically, as best shown in FIG. 3, one of the blade members 12 has an elongated slot 32 positioned to overlie the pivot axis 31 when forming part of the shears, while the other blade member 22 has a tang in the shape of a generally rectangular protrusion 34 that is sized and positioned to be inserted within the slot 32 when the slot is rotated into overlying alignment with the protrusion (as best illustrated in FIG. 4). Thus the blade members can be assembled to form the shear, or disassembled from each other, when the protrusion and slot are so aligned. Those of ordinary skill in the art will recognize that numerous other mate-able geometric shapes may be utilized to provide this type of “keyhole” locking function wherein the blade members may be pivoted into relative positions that enable one blade member to be detached from the other while remaining captured during the shearing operation. All such mate-able shapes are within the scope of this invention.

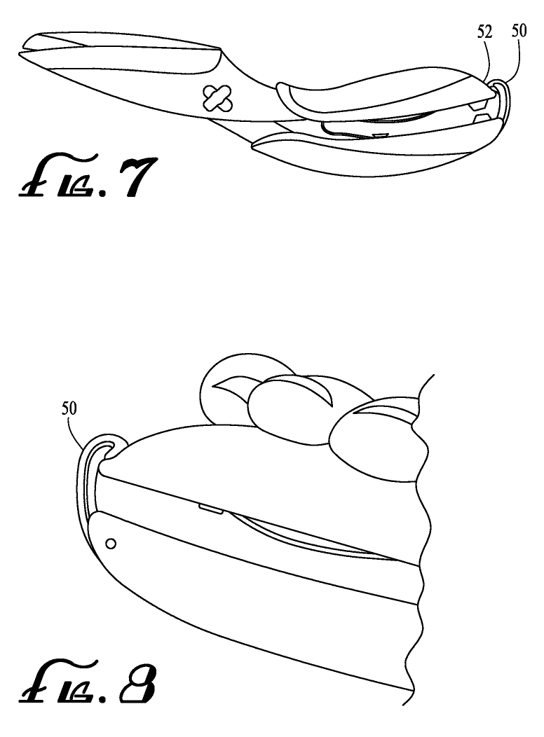

As illustrated best in FIG. 10, the protrusion 34 is generally T-shaped, with a short generally cylindrical shaft 35 extending from the blade member supporting the generally rectangular protrusion. A comparison of FIGS. 1 and 7 illustrate how the blade member 12 is captured through its slot 32 by the rectangular protrusion 34 so that the blade members 12, 22 remain coupled together as the slot rotates about the shaft 35 in response to the opening and closing movement of the cutting edges 16, 26. As best shown by comparing FIGS. 1 and 4, the further separation of the handle regions from their normally open positions (FIG. 1) results in the aligning of the protrusion 34 and slot 32, permitting disassembly into the components shown in FIG. 3.

The shears are preferably biased into the normally open position by a spring. As illustrated in FIGS. 1 and 2, a leaf spring 40 is accordingly affixed to the handle portion 24 of the blade member 22 for contact by the handle portion 14 of blade member 12. As the handle portions 14, 14 of the shears are squeezed together, the leaf spring 40 is compressed therebetween as best shown in FIG. 6, thereby returning the shears to its normally open position as the squeezing force on the handle portions is relaxed.

In accordance with the invention, and as best shown in FIG. 3, the blade member 12 becomes a paring knife when disassembled from the shears, so that it can be used to slice, dice, and otherwise cut food items. The cutting region 16 of the blade member 12 is accordingly provided with a knife edge preferably comprising a bevel on only one side; namely, its outer side. Its inner side—i.e., the surface facing the blade member 22 when forming part of the shears—has little or no bevel so that it cuts with the normal shearing force associated with shears. By this configuration, the blade region of both blade members have substantially continuous contact with each other as the blades transition between the shear's open and closed positions.

The handle portion 14 of the blade member 12 is preferably a loopless, knife-type handle rather than the typical looped handle associated with shears. Preferably, the other handle portion 24 is similarly shaped for aesthetics and comfort. Preferably, both handles portions are contoured to comfortably fit the human hand when forming part of the shears and, in the case of handle portion 14 at least, when gripping the blade member for use as a knife.

As illustrated in FIG. 3, the paring knife formed by blade member 12 is free of components unneeded by the knife but desirable for the shear. It is the other blade member 22 that carries the leaf spring 40, the protrusion 24 and the locking device 50. Those skilled in the art recognize that a knife edge is sharper than a shear blade; shear blades depend on shearing force to make a cut while knife blades typically utilize a steeper bevel and a sharper edge. As indicated above, the blade member 12 preferably has a knife edge.

Those of ordinary skill in the art will recognize that many other elements can be used to provide a releasable or unlockable coupling mechanism at the pivot point of the shears to enable a blade member to be separately used as a knife. Push-button mechanisms, key-and-keyhole combinations, snaps, releasable pins, manually actuatable screws, threaded thumbwheels and wing nuts, thumb-operated cam mechanisms and numerous other devices are known and readable usable once the foregoing information about the invention has been obtained. All of these mechanisms and devices are within the scope of the invention, and their inclusion is intended.

Similarly, the fact that the blade member 12 preferably becomes a paring knife does not exclude other types of knives from the scope of the invention.

While the foregoing is a detailed description of a preferred embodiment of the invention, it is intended that the scope of the invention not be limited to that specific embodiment. Rather, the scope of the invention is to be defined by the claims which follow.

I claim:

1. Shears for cutting an item comprising:
a pair of blade members having respective handle portions at their proximal end regions and respective cutting edges at their distal end regions, and
a coupling mechanism for coupling the blade members for pivoting movement with respect to each other about a pivot axis generally perpendicular to the blade members so that the cutting edges can be pivoted towards and away from each other about said axis, the coupling mechanism being manually operable to selectively decouple the blade members from each other, at least one of the blade members having a knife edge along its distal end region so it can function as a knife when separated from the other blade member.

2. The shears of claim 1 wherein said at least one blade member is a paring knife when separated from the other blade member.

3. The shears of claim 1 wherein said other blade member has serrations on its outer surface adjacent its cutting edge for resisting the slippage of the item being cut from between the two cutting edges owing to the shearing force of the blades.

4. The shears of claim 1 wherein the coupling mechanism includes a protrusion extending generally about the pivot axis from one of the blade members, and
wherein the other of the blade members includes a slot positioned to generally encompass the protrusion when forming part of the shears,
the protrusion and slot being mutually shaped to provide an interlocking relationship that permits the blade members to be pivoted into relative positions that enable one blade member to be detached from the other while remaining captured during the shearing operation.

5. The shears of claim 4 wherein the protrusion is generally rectangular in shape and said other blade member has an elongated slot,
the protrusion and slot being mutually sized and positioned for insertion of the protrusion into the slot when the slot is rotated into overlying alignment with the protrusion to permit assembly and disassembly of the shears.

6. The shears of claim 4 wherein the protrusion is generally T-shaped, with a short generally cylindrical shaft extending from said one blade member and a generally rectangular top surface, and
said other blade member has an elongated slot for capturing the rectangular top surface of the protrusion when the slot encompasses the generally cylindrical shaft thereof so that the blade members remain coupled together for relative pivoting movement as the slot rotates about the shaft.

7. The shears of claim 6 wherein the protrusion and shaft are sized and positioned so that the separation of the handle regions beyond their normally their normally open positions results in the aligning of the generally rectangular top surface of the protrusion with the elongated slot, permitting disassembly of the shears.

8. The shears of claim 1 wherein the cutting region of said at least one knife blade member has a knife edge comprising a bevel on only one side.

9. The shears of claim 8 wherein said one side is the outer side.

10. The shears of claim 1 including means for biasing the shears into a normally open position for returning the shears to said normally open position as squeezing force on the handle portions is relaxed.

11. The shears of claim 1 wherein the biasing means is affixed to one of the blade members.

12. The shears of claim 11 wherein the biasing means is not affixed to the other of the blade members.

13. The shears of claim 11 wherein the biasing means is not attached to said at least one blade member having the knife edge.

14. The shears of claim 13 wherein the biasing means is a spring.
